(19) United States
(12) Patent Application Publication
(10) Pub. No.: US 2021/0329906 A1
(43) Pub. Date: Oct. 28, 2021

(54) APPARATUS FOR SPRAYING INSECTICIDES

(71) Applicant: FaunaPhotonics Agriculture & Environmental A/S, Copenhagen SV (DK)

(72) Inventors: Frederik Taarnhøj, Charlottenlund (DK); Klas Rydhmer, Malmö (SE); Alfred Gösta Victor Strand, Malmö (SE); Flemming Rasmussen, Frederiksberg (DK); Michael Stanley Pedersen, Frederiksberg (DK); Thomas Nikolajsen, Slangerup (DK)

(21) Appl. No.: 17/271,648

(22) PCT Filed: Aug. 29, 2019
(86) PCT No.: PCT/EP2019/073146

§ 371 Date: Feb. 26, 2021

(30) Foreign Application Priority Data
Aug. 31, 2018 (DK) PA 2018 70566

(51) Int. Cl. A01M 7/00; G06K 9/20; G06K 9/00; G05D 7/06

(52) U.S. Cl. CPC A01M 7/0089; A01M 7/0042; G05D 7/0623; G06K 9/00791; G06K 9/2018

(57) ABSTRACT

An apparatus for dispensing an insecticide across an area of land; the apparatus comprising a vehicle configured to travel along a travelling path across the area of land, the vehicle defining a direction of travel, the vehicle comprising an insecticide dispensing device configured to dispense an insecticide along said traveling path when the vehicle travels along the travelling path; a dispensing control system configured to control an amount of insecticide to be dispensed when the vehicle travels along the travelling path; an insect sensor configured to detect insects in a detection volume; wherein the detection volume is located in front of the vehicle relative to the direction of travel;

wherein the dispensing control system is configured to receive sensor data from the insect sensor, the sensor data being indicative of detected insects in the detection volume, and to control the amount of dispensed insecticide responsive to the received sensor data.

### TECHNICAL FIELD

The present disclosure relates to an apparatus for spraying insecticides, to a method and apparatus for controlling the spraying of insecticides and to an insect sensor for detecting insecticides.

### BACKGROUND

It is generally desirable to optimize the use of insecticides in agriculture.

In particular, when distributing insecticides across a field of crops or other area on which insects are to be controlled, it is generally desirable to apply the right types of insecticides in the right amounts so as to obtain an efficient insect control while not applying unnecessary, useless or even environmentally harmful amounts of insecticides.

In this respect, the number of insects may vary over time but also across a given area which makes application of efficient amounts of insecticides a challenging task. In particular, insects are often non-uniformly distributed across an area and hot spots of locally high insect concentrations may occur. Moreover, the location of such hot spots may change over time.

WO 2016/025848 discloses a mobile platform structured and operable to perform: in-field phenotype and/or genotype data acquisition; image data acquisition; tissue sampling; selection and/or counting of plants growing in a plot; plant height measurement; product and treatment application to plants growing in the plot (e.g., prescriptive and localized insecticide products); sampling of soil where such plants are growing; removal of weeds in such plots; and real-time analysis of all such data and/or samples acquired/collected. In particular, the mobile platform includes an imaging device suspended above the ground surface and having a downward directed field of view encompassing one or more plants in a desired number of rows of plants.

U.S. Pat. No. 9,655,356 discloses a lawn treatment apparatus that employs a scanner to detect the presence of an area to be selectively treated with an herbicide, pesticide or fungicide. The apparatus includes a multicompartmental cartridge that holds different chemicals and selectively applies the chemicals. In particular, this prior art document describes a lawnmower that hosts a front scanner that optically scans an area in front of the lawnmower. The front scanner emits a light beam used to illuminate grass/weeds/insect-mounds in front of the lawnmower.

While the above prior art systems provide systems for detecting pest-infested plants or insect mounds on the ground, it remains a problem that many agricultural machines disturb the insects as the machine travels through a field. Moreover many of the insects to be treated against can fly or jump and may thus fly or jump away, in particular when disturbed by the agricultural machine, which renders their detection more difficult.

It is thus generally desirable to provide a more reliable detection and identification of insects, in particular in a vicinity of a moving agricultural vehicle.

Furthermore, it is generally desirable to provide an easy-to-use and efficient apparatus for dispensing insecticides across an area of land.

It further remains desirable to provide a low complex, yet reliable insect sensor that allows fast detection of moving insects.

### SUMMARY

According to one aspect, disclosed herein are embodiments of an apparatus for dispensing an insecticide across an area of land, the area of land defining a ground surface. The apparatus comprises:
a vehicle configured to travel along a travelling path across the ground surface, the vehicle defining a direction of travel, the vehicle comprising an insecticide dispensing device configured to dispense an insecticide along said traveling path when the vehicle travels along the travelling path;
a dispensing control system configured to control an amount of insecticide to be dispensed when the vehicle travels along the travelling path;
an insect sensor configured to detect airborne insects in a detection volume while the detection volume moves relative to the ground surface; wherein the detection volume is located in front of the vehicle relative to the direction of travel and elevated above the ground surface by a minimum vertical offset;

wherein the dispensing control system is configured to receive sensor data from the insect sensor, the sensor data being indicative of detected insects in the detection volume, and to control the dispensing of the insecticide responsive to the received sensor data.

In particular, the sensor data may be indicative of an amount of insects detected in the moving detection volume during a sampling period. The dispensing control system may thus be configured to control the dispensing of the insecticide onto a dispensing site responsive to the sensor data indicative of a local insect population, in particular indicative of detected insects in a detection volume above a detection site which is in a proximity of the dispensing site.

Accordingly, the apparatus may locally adjust the dispensing of the insecticide according the actual presence of insects at or near said location, i.e. vary the amount of insecticide dispensed along the travelling path responsive to the detected insects, thus facilitating efficient use of the insecticide. Moreover, as the dispensing is based on detected insects in front of the dispensing vehicle and above the ground surface, the control is adapted to current and local information and takes airborne insects into account, in particular flying or jumping insects.

The control of the dispensing may comprise controlling the amount of insecticide to be dispensed and/or the type of insecticide to be dispensed at any given location along the travelling path. To this end, the dispensing control system may be configured to control one or more valves, pumps and/or other flow-control devices so as to control the amount of insecticide—or of selected types of insecticide—being dispensed by one or more dispensers.

The dispensing may e.g. be controlled by causing insecticide to be dispensed only when the detected amount of insects (or the detected amount of insects of a certain type) is above a predetermined threshold. In some embodiments, the vehicle is configured to dispense insecticide from multiple ports, such as nozzles, e.g. such that respective ports dispense insecticide onto respective locations. The dispensing control system may then control the dispensing of insecticides through selected ones of the ports, thus allowing an even more fine-grained control of the dispensing. Such selective dispensing may e.g. be done responsive to the detection of insects in corresponding part volumes of the detection volume.

The vehicle may be a ground vehicle, i.e. a vehicle that operates while in contact with the ground surface. A ground vehicle may e.g. drive on wheels or the like. For example, the ground vehicle may be a tractor or other farming vehicle. Other examples of vehicles include aerial vehicles such as an airplane, a helicopter or the like. The vehicle may be a manned vehicle or an unmanned vehicle.

The detection volume may have a variety of shapes and sizes, such as box-shaped, cylindrical, ball-shaped, cone-shaped, pyramidal, frusto-conical, frusto-pyramidal, etc. In some embodiments, the detection volume has a size of at least 0.2 m³, such as at least 0.5 m³, such as at least 1 m³, such as at least 2 m³, such as at least 3 m³. In some embodiments, the detection volume has an aspect ratio, e.g. defined as a ratio of a largest edge to a smallest edge of a minimum bounding box of the detection volume, of no more than 10:1, such as no more than 5:1, such as no more than 3:1, such as no more than 2:1. For example, the aspect ratio may be between 1:1 and 10:1, such as between 1:1 and 5:1, such as between 1:1 and 3:1, such as between 2:1 and 3:1. The minimum bounding box may have a vertical and two horizontal edges. The vertical edge may be the smallest edge of the minimum bounding box. For example, a ratio between each of the horizontal edges and the vertical edge may be between 2:1 and 10:1, such as between 2:1 and 5:1, such as between 2:1 and 3:1.

It has turned out that a detection volume of at least 0.2 m³, such as at least 0.5 m³, such as at least 1 m³, such as at least 2 m³, such as at least 3 m³ is sufficient to detect insect populations with sufficient accuracy to allow efficient control of the dispensing of insecticide. It has further turned out that a low aspect ratio of the detection volume allows moving insects to be tracked over a relative long period of time, regardless of the direction of travel of the insects, thus allowing more accurate detection and identification of the insects.

The detection volume is elevated above the ground surface by a minimum vertical offset. In some embodiments, the detection volume extends from a top of a vegetation canopy upwards. Accordingly, interference of the vegetation with the insect sensor, e.g. by blocking the light path, is thus avoided or at least reduced. To this end, the minimum vertical offset may be predetermined, e.g. configurable prior to use, e.g. so as to adapt the minimum vertical offset to the dimensions of the vehicle on which the insect sensor is mounted and/or to the current vegetation to be treated. For example, the insect sensor may be mounted to the vehicle such that the vertical offset of the insect sensor above the ground surface is adjustable and/or such that the orientation of the insect sensor relative to the ground surface is adjustable. The size of the vertical offset may depend on the height of the vegetation growing in the area of land to be treated. It may be larger than a height of the vegetation, e.g. larger than a maximum height of population of plants making up the vegetation to be treated, or larger than a median height of population of plants to be treated. For example, the minimum vertical offset may be chosen between 10 cm and 5 m, such as between 20 cm and 3 m, such as between 20 cm and 2 m, such as between 50 cm and 2 m.

Embodiments of the insect sensor described herein are particularly suitable for detecting airborne insects, such as flying or jumping insects, in particular for detecting such insects from a moving vehicle. Embodiments of the insect sensor described herein allow for detection of insects moving within the detection volume during sufficiently long observation times so as to reliably identify and distinguish different types of insects using e.g. a detection of wing beat frequencies and/or a classification of trajectories.

Such techniques have been found to provide reliable insect detection and identification when individual insects remain in the detection volume sufficiently long.

In some embodiments, the insect sensor comprises an illumination module configured to illuminate the detection volume, in particular the entire detection volume, and a detector module comprising one or more detectors configured to detect light from the detection volume, in particular from the entire detection volume. In particular, the illumination module is configured to illuminate the detection volume with illumination light and the detector module is configured to detect a backscattered portion of the illumination light, the backscattered portion being backscattered by insects moving about the detection volume. The inventors have found that a reliable detection and/or identification of insects can be performed by detecting and analyzing light, in particular backscattered light, from illuminated insects.

The detection volume is a 3D volume from which the insect sensor obtains sensor input suitable for the detection of insects. The detection volume may thus completely or partly be defined by the field of view and depth of field of the detector module. In embodiments where the detection volume is illuminated by an illumination module, the detection volume may be defined as an overlap of the volume illuminated by the illumination module and by a volume defined by the field of view and depth of field of the detector module.

The detection volume may have a predetermined shape, size and position relative to the illumination module and relative to the detector module, e.g. relative to an aperture and/or an optical axis of the detector module. In particular, the detection volume may, during the entire detection process, be stationary relative to the detector module and to the illumination module. Accordingly the detector module may comprise one or more lenses that define an optical axis of the detector module and and/or that define a focal length. The focal length may be fixed during the entire detection process. Moreover, the optical axis may be fixed, e.g. relative to the illumination module and/or relative to a housing of the apparatus, during the entire detection process. However, it will be appreciated that the apparatus may allow the size, shape and/or relative position of the detection volume to be pre-configured and adapted to a specific measurement environment, e.g. by changing a relative position and/or orientation of the illumination module and the detector module. The detector module may further comprise an aperture.

In some embodiments, the detection volume has a size of less than 20 m³, such as less than 10 m³, such as at less than 5 m³, thereby facilitating uniform illumination at high brightness of the entire detection volume while allowing for reliable detection of trajectories and/or wing beat frequencies.

In some embodiments, the illumination module comprises a light source that is configured to emit incoherent light. Suitable light sources include light-emitting diodes (LEDs) and halogen lamps, as these are able to simultaneously illuminate large detection volumes with sufficient light intensity. Further incoherent light sources are useful to provide a homogeneous, speckle free, illumination of the detection volume, in particular a simultaneous illumination of a large detection volume without the need for any scanning operation. This reduces the complexity of the optical system and allows reliable detection of wing beat frequencies and/or trajectories even of fast-moving insects.

Nevertheless, other light sources, including coherent light sources, such as lasers, may be used instead. In some embodiments, the light source is configured to output light continuously while, in other embodiments, the light is turned on and off intermittently, e.g. pulsed.

In some embodiments, the illumination module comprises a light source that is configured to emit coherent or incoherent visible light and/or infrared and/or near-infrared light and/or light in one or more other wavelength ranges. Infrared and/or near-infrared light (such as light in the wavelength range between 700 nm and 1500 nm, such as between 700 nm and 1000 nm) is not detectable by many insects, and thus does not influence the insect's behaviour.

In some embodiments, the illumination module is configured to selectively illuminate the detection volume with light of two or more wavelength ranges, in particular two or more mutually spaced-apart wavelength ranges. To this end, the illumination module may include a first light source, e.g. comprising one or more LEDs, configured to selectively emit light of a first wavelength range. The illumination module may further include a second light source, e.g. comprising one or more LEDs, configured to selectively emit light of a second wavelength range which may be spaced-apart from the first wavelength range. The detector module may be configured to selectively detect the selected wavelength ranges. In one embodiment, the illumination module is configured to emit light at a first wavelength range at 810 nm+/−25 nm and light at a second wavelength range at 980 nm+/−25 nm. Such a multi-spectral illumination system facilitates color detection of moving insects.

A convenient illumination of a relatively large detection volume, in particular a simultaneous illumination of the detection volume, with a compact illumination module, may e.g. be provided when the illumination module is configured to emit a diverging beam of light, in particular a beam of light having a divergence angle in at least one direction of between 2° and 45°, such as between 10° and 30°, measured as a full angle between rays originating from the light source and intersecting opposite ends of a beam diameter.

The illumination module may e.g. include one or more optical elements, such as one or more reflectors and/or one or more lenses, that direct the light from the light source as a beam of light, such as a diverging beam of light, of a suitable cross-sectional shape towards the detection volume. For example, the beam of light may have a rectangular or round, e.g. oval or circular, cross section. Accordingly, the detection volume may have a frusto-conical or frusto-pyramidal shape.

When detecting moving insects in a field of vegetation, it has turned out that a frusto-conical or frusto-pyramidal detection volume having an elongated (e.g. elliptical or rectangular) base/cross section is particularly advantageous. In particular, when the elongated cross-section/base has a width (measured in a horizontal direction) that is larger than a height (measured in a vertical direction), e.g. such that the ratio between the width and the height is at least 3:2, such as at least 2:1, e.g. between 3:2 and 5:1, such as between 3:2 and 3:1, such as between 2:1 and 3:1. A detection volume having an elongated cross section with a horizontal longitudinal axis where the detection volume is elevated above the ground surface by a minimum vertical offset allows the detection volume to be arranged as a relatively flat volume, e.g. a flat box-shaped volume or a volume generally shaped as a flat pie slice, that is horizontally arranged above a canopy of vegetation. Such a volume reduces reflections, stray light or other disturbing effects of the plants that might otherwise interfere with the detection process. Also, the inventors have realized that such a detection volume makes efficient use of the available illumination power to illuminate a volume where most insect activity occurs.

As, in some embodiments, the detection volume is defined by an overlap between the illumination volume and the field of view and depth of field of the detector module, the illumination module may be configured to illuminate a conical or pyramidal or frusto-conical or frusto-pyramidal illumination volume, in particular with an elongated base/cross-section as described above with reference to the detection volume.

In some embodiments, the detector module comprises a camera, in particular a camera having a field of view and a depth of field large enough to record focused images of the entire detection volume. The camera allows detection of disturbing events, e.g. larger animals or plants crossing the detection area. The camera may also serve as a detector for detecting background radiation. In some embodiments, the captured images may be used by the processor to detect and/or identify insects, e.g. by detecting airborne trajectories of the insects and identifying types pf insects based on their respective trajectory patterns. An example of an insect identification process based on recorded insect trajectories is described in co-pending International patent application No. PCT/EP2019/073119.

The identification technique described in International patent application PCT/EP2019/073119 may be implemented by the processor of the present apparatus for detecting insects. It has been found that the trajectory-based detection is particularly useful when detecting insects in large detection volumes in front of an insecticide-dispensing vehicle. In particular, the trajectory-based detection has been found to be particularly useful in a system using multiple detection techniques as respective indicators for different types of insects and configured to identify detected insects based on a classifier using multiple indicators as inputs. For example, the trajectory-based detection may be combined with one or more of the detection techniques described below.

In some embodiments, the one or more detectors comprise one or more photo diodes. Individual photodiodes that receive light from the entire detection volume or from a part of the detection volume allow for a fast time-resolved detection of changes in the intensity of backscattered light. Such signals may be used to determine wing beat frequencies of flying insects which, in turn, may be used to detect the presence of insects and, optionally, to distinguish between different types of insects based on properties of the wing beat patterns, e.g. the relative amplitudes of multiple frequencies in a frequency spectrum associated with a detected insect event.

In some embodiments the detector module comprises an array of photodiodes, e.g. a linear array or a 2D array. The detector module may be configured to direct light from different sub-volumes of the detection volume onto respective photo-diodes of the array, thus allowing a space-resolved detection of insects based on the photodiodes.

In some embodiments, the photodiode or photodiode array is configured to selectively detect light at a predetermined wavelength or small wavelength band. In some embodiments, the detector module is configured to selectively detect light at two or more wavelengths or small wavelength bands where the two or more wavelengths or wavelength bands are spaced apart from each other and do not overlap each other. To this end, the detector module may comprise one or more photodiodes or photodiode arrays configured to selectively detect light at two or more wavelengths or small wavelength bands where the two or more wavelengths or wavelength bands are spaced apart from each other and do not overlap each other. This may e.g. be achieved by a single photodiode array where respective bandpass filters are selectively and alternatingly positioned in front of the photodiode or photodiode array. Alternatively, the detector may include two or more photodiodes or photodiode arrays, each configured to detect light at a respective wavelength or wavelength band. In particular a detector module configured to selectively detect light at 808 nm and at 970 nm, respectively (e.g. by respective photo diodes) has been found to be suitable for detecting and distinguishing different type of insects, e.g. based on a ratio of backscattered light at the respective wavelength. Generally, in some embodiments, the one or more photodiodes comprise at least a first photodiode configured to selectively detect light within a first wavelength band; and at least a second photodiode configured to selectively detect light within a second wavelength band, non-overlapping with the first wavelength band.

Generally, the detector module may include a single detector or multiple detectors. Accordingly, the insect sensor may comprise a processor configured to determine, from detector signals from the one or more detectors, an amount, e.g. a number, of insects detected in the detection volume. In some embodiments, the processor is configured to identify, from detector signals from the one or more detectors, one or more types of insects and to determine respective amounts of the one or more types of insects detected in the detection volume. Accordingly, the dispensing control system may control the dispensing of insecticides so as to selectively target certain types of insects. Moreover, the dispensing control system may control the amount of dispensed insecticide according to the detected amount of insects or of certain types of insects.

To this end, the processor may process the detector signals so as to detect one or more indicators indicative of the presence of one or more insects in the detection volume and count the number of detected insects, e.g. within a predetermined time period, a sliding window or the like, so as to determine an estimate of an amount of insects detected in the detection volume, e.g. as a number of insects detected in the detection volume, e.g. per unit time and/or per unit volume. The processor may even be configured to detect one or more indicators indicative of the type of detected insects and selectively determine an estimate of the detected amount of one or more types of insects, e.g. one or more species of insects, insects responsive to specific types of insecticides, etc. To this end, the processor may implement a suitable classifier model, e.g. based on neural networks and/or other classification techniques configured to determine a detected presence of an insect and/or an identify of a detected insect from a set of indicators. Generally, the processor may output sensor data indicative of a number of insects detected during a sampling period in the moving detection volume or another parameter indicative of an estimated local insect population in the detection volume and/or in the sampling volume traversed by the detection volume.

In some embodiments, the processor is configured to identify the one or more types of insects based on one or more indicators chosen from:
a detected trajectory of movement of an insect inside the detection volume;
a detected speed of movement of an insect inside the detection volume;
one or more detected wing beat frequencies;
a melanisation ratio;
an insect glossiness.

The detection and/or identification of insects based on wing beat frequencies, melanisation ratios and insect glossiness is described in more detail in WO 2018/182440 and in Gebru et. Al: “Multiband modulation spectroscopy for the determination of sex and species of mosquitoes in flight”, J. Biophotonics. 2018. While the above documents describe these indicators in the context of LIDAR system using the Scheimflug principle, the present inventors have realized that these techniques may also be applied to a detector system based on other light sources that illuminate an extended volume rather than a narrow laser beam.

The apparatus thus processes the sensor signals to compute sensor data indicative of an amount of insects detected in the moving detection volume. The amount of detected insects may serve as an estimate of the local insect population in a sampling volume traversed by the detection volume during the measurement period. Based on the detected insects and/or on a resulting estimated insect population and/or populations of respective types of insects, the dispensing control system may select one or more suitable insecticides, corresponding amounts to be applied to a specific location and control the output ports of the system to dispense the selected amount onto. To this end, the processor determining the amount of detected insects and/or estimating the insect population may communicate sensor data indicative of the determined amount of insects detected in the detection volume and/or otherwise of an estimated local insect population to the dispensing control system. In some embodiments, the dispensing control system and the processor of the insect sensor may be integrated into a single processing module, i.e. the processor for processing the sensor signals to detect and, optionally, identify insects may be included in the dispensing control system.

As the vehicle moves across the area of land, the detection volume moves along with the vehicle, and the insect sensor continuously or at least repeatedly updates the estimated insect populations ahead of the vehicle. Hence, the dispensing control system may control the dispensed insecticide (e.g. amount and/or type) responsive to the currently estimated insect population, e.g. responsive to the local insect population.

In some embodiments the insect sensor is mounted on a vehicle separate from the vehicle distributing the insecticide. For example, the insect sensor may be mounted on a drone moving ahead of the vehicle. In other embodiments, the insect sensor is mounted on the vehicle dispensing the insecticide, thus providing a less complex, easy-to-use system. The insect sensor may be mounted on an arm, frame, rack or other mounting structure which is mounted at or proximal to the forward-facing end of the vehicle. In some embodiments, the mounting structure is adjustably mounted to the vehicle, e.g. such that a vertical offset of the insect sensor above the ground can be adapted, e.g. depending on the height of the vegetation and/or the types of insects to be detected.

Similarly the orientation of the insect sensor relative to forward direction of the vehicle may be adjustable so as to adjust the location of the detection volume relative to the vehicle. For example, in some situations a low positioning of the sensor but with an forward or with an upward-forward facing field of view may be desirable, while other situations may favor a high position with a forward or downward-forward facing field of view. The adjustment of the position and/or orientation of the sensor may be made manually or automatically.

When the sensor is generally forward facing, i.e. that the detection volume is ahead of the vehicle along the travelling path, the detection volume is less disturbed by the driving of the vehicle, e.g. by dust, exhaust fumes, or the like. Similarly, the system can process the sensor data from the detection volume at a first location along the travelling path during the time required for the vehicle to reach the first location, i.e. such that the control of the dispensing of the insecticide can be adapted to the first location based on data acquired at said first location.

The present disclosure relates to different aspects including the apparatus described above and in the following, corresponding apparatus, systems, methods, and/or products, each yielding one or more of the benefits and advantages described in connection with one or more of the other aspects, and each having one or more embodiments corresponding to the embodiments described in connection with one or more of the other aspects and/or disclosed in the appended claims.

In particular, according to one aspect, the present disclosure relates to an insect sensor.

The insect sensor may be mountable to a vehicle, the vehicle being configured to travel along a travelling path across the area of land, the vehicle defining a direction of travel, the vehicle comprising an insecticide dispensing device configured to dispense an insecticide along said traveling path when the vehicle travels along the travelling path; the insect senor being configured, when mounted to the vehicle, to detect insects in a detection volume; wherein the detection volume is located in front of the vehicle relative to the direction of travel; the insect sensor being configured to provide sensor data to a dispensing control system wherein the dispensing control system is configured to receive sensor data from the insect sensor, the sensor data being indicative of detected insects in the detection volume, and to control the amount of dispensed insecticide responsive to the received sensor data.

In particular, according to one aspect, disclosed herein are embodiments of an insect sensor for detecting airborne insects moving above a ground surface, the insect sensor comprising:
an illumination module configured to illuminate a detection volume, the detection volume being elevated from the ground surface by a minimum vertical offset, and
one or more detectors configured to detected light from the detection volume;

wherein the illumination module is configured to emit a diverging beam of light, in particular having a divergence angle in at least one direction of between 2° and 45°, such as between 10° and 30°.

Embodiments of the insect sensor described herein are robust and have low complexity, thus making them cost efficient, durable and suitable for being deployed on moving vehicles. Moreover, embodiments of the insect sensor described herein allow for a reliable detection and classification of moving airborne insects.

It will be appreciated that insects vary a lot in size and behavior. Insect sizes can vary from less than one mm to a few cm and movement patterns of insects can vary from insects standing still, hovering, in air to jumping insects with ballistic trajectories.

Embodiments of the apparatus and insect sensor described herein have been found useful for various types of airborne insects, including flying insects having wings and jumping insects, such as jumping flea beetle, e.g. cabbage stem flea beetle (Psylliodes chrysocephala).

Considering a jumping flea jumping to a height of h, the vertical speed by which the flea leaves the ground to reach this height can be estimated assuming a substantially ballistic flight path. For example, considering a flea jumping 0.5 m above the ground the initial vertical speed of the flea will of the order of 3.2 m/s which gives and order of magnitude by which the ballistic insects move in space. In order to capture such a fast event involving insects having a size down to less than 5-10 mm, the detection volume, and hence the illuminated volume has to have an extent to cover the essential part of the trajectory and detection speed to resolve the motion in time. Moreover, the detector module needs to resolve such events in time and space. Similarly, as discussed herein detection of flying insects based on wing beat patterns impose similar requirements on the detection volume and the time and space resolution of the insect sensor.

In some embodiments, the insect sensor and the dispensing control system are provided as a single unit that is mountable on the vehicle and configured to communicate with the vehicles dispensing device so as control the dispensing of insecticide from the dispensing device.

Here and in the following, the term processor is intended to comprise any circuit and/or device suitably adapted to perform the functions described herein. In particular, the term processor comprises a general- or special-purpose programmable microprocessor, such as a central processing unit (CPU) of a computer or of another data processing system, a digital signal processor (DSP), an application specific integrated circuits (ASIC), a programmable logic arrays (PLA), a field programmable gate array (FPGA), a special purpose electronic circuit, etc., or a combination thereof. It will be appreciated that the processor and/or the dispensing control system may be implemented as a client-server or a similar distributed system, where the acquisition and, optionally, some signal processing, is performed locally in the vehicle, while other parts of the data processing and classification tasks may be performed by a remote host system in communication with the client device.

According to another aspect, disclosed herein are embodiments of a method of controlling the spraying of insecticides, the method comprising:
detecting airborne insects moving about a detection volume, the detection volume being located in front of a moving vehicle and the detection volume being elevated above a ground surface by a minimum vertical offset;
controlling the dispensing of insecticides from said moving vehicle responsive to the detection of airborne insects.

According to another aspect, disclosed herein are embodiments of an apparatus for controlling spraying of insecticides, the apparatus comprising an insect sensor as disclosed above and in the following, and a control system, e.g. a computer-implemented control system, configured to output a control signal for controlling an insecticide dispenser responsive to a detection signal from the insect sensor.

Additional features and advantages will be made apparent from the following detailed description of embodiments that proceeds with reference to the accompanying drawings.

### BRIEF DESCRIPTION OF THE DRAWINGS

Preferred embodiments will be described in more detail in connection with the appended drawings, where

FIG. 1 shows a schematic view of an apparatus for spraying insecticides.

FIG. 2 schematically illustrates operation of an apparatus for spraying insecticides.

FIG. 3 schematically illustrates an embodiment of an insect sensor.

FIG. 4 schematically illustrates an example of a detector module of an insect sensor.

FIG. 5 schematically illustrates another example of a detector module of an insect sensor.

FIG. 6 schematically illustrates another embodiment of an insect sensor.

FIG. 7 schematically illustrates an example of a sensor signal form a detector module of an embodiment of an insect sensor as described herein.

FIGS. 8 and 9 illustrate examples of detection volumes.

### DETAILED DESCRIPTION

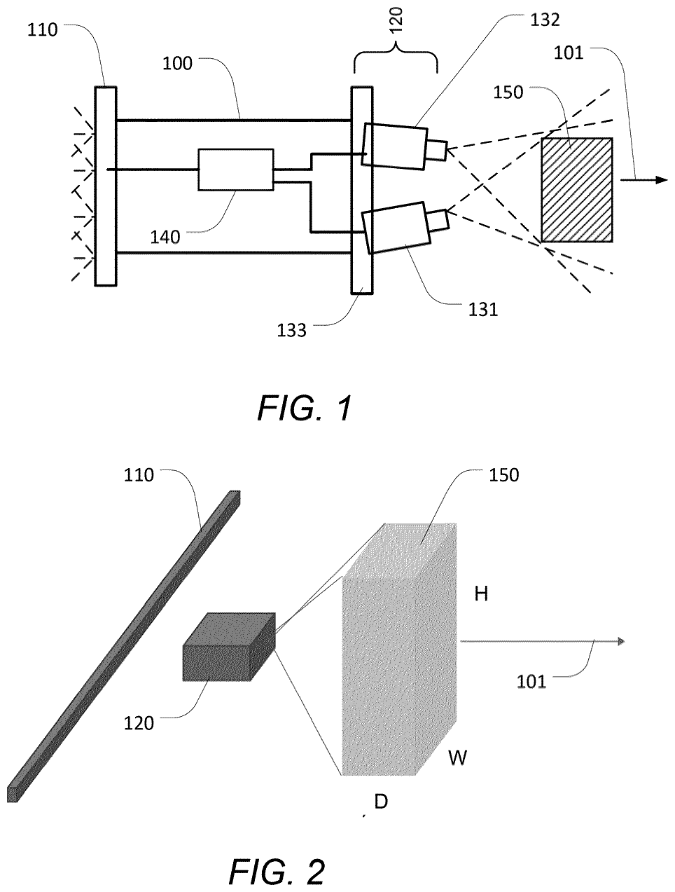

FIG. 1 shows a schematic top view of an apparatus for spraying insecticides. The apparatus comprises a farming vehicle 100, such as a tractor or other ground vehicle. It will be appreciated that, alternatively, an aerial vehicle may be employed.

The vehicle is configured to travel along a travelling path across a field or other ground surface of ab area of land on which insect control is to be performed. The vehicle defines a direction of travel as illustrated by arrow 101. The direction of travel will also be referred to as forward direction relative to the vehicle.

The vehicle comprises an insecticide dispensing device 110 comprising one or more outlet ports for dispensing insecticide. For example, the dispensing device 110 may comprise an arm extending along a lateral direction, i.e. across the direction of travel 101. A plurality of sprayer nozzles are positioned on the arm, e.g. distributed across the length of the arm. The dispensing device may be arranged at or towards the rear of the vehicle, though other positions are possible as well. The vehicle further comprises a dispensing control unit 140, e.g. a suitable controller circuit such as a suitably programmed microprocessor or the like. The dispensing control unit is operatively coupled to the dispensing device and operable to control the amount of insecticide dispensed by the dispensing device 110. To this end, the dispensing control device may be operable to control a valve or similar flow control device for controlling the insecticide flow from an insecticide reservoir (not explicitly shown) to the output ports of the dispensing device. In some embodiments, the dispensing control unit 140 may control multiple valves for controlling insecticide flow to the respective individual output ports. In some embodiments, the vehicle may comprise multiple insecticide reservoirs, e.g. for storing different types of insecticides. In such an embodiment, the dispensing control unit may be operable to selectively control insecticide flow from the respective reservoirs to the dispensing device, e.g. so as to control which type of insecticide or combination of insecticides is to be dispensed. The dispensing control unit may control the dispensing of insecticides in real-time i.e. change the amount and/or type of insecticide to be dispensed while the vehicle travels along a travelling path. Accordingly, the dispensing control unit may cause different amounts and/or types of insecticide to be dispensed at different locations along the travelling path.

The apparatus further comprises an insect sensor 120 for detecting insects in front of the vehicle 100 while the vehicle is travelling in the direction of travel 101. To this end, the insect sensor may be mounted at or proximal to the front end of the vehicle.

Alternatively, the insect sensor may be mounted at a different location of the vehicle or even be provided on a separate vehicle, e.g. a drone or unmanned ground vehicle travelling in front of, next to or above the vehicle 100.

The insect sensor 120 of the embodiment of FIG. 1 comprises an arm or frame 133 that is mounted to the front end of the vehicle. The insect sensor further comprises an illumination module 131 and a detector module 130, each mounted to the arm or frame 133. It will be appreciated, that other embodiments may include more than one illumination module and/or more than one detector module. It will further be appreciated that the illumination module and the detector module may be provided as separate devices, i.e. each module may have its own housing. In other embodiments the illumination module and the detector module may be accommodated in a single housing or otherwise form a single unit. In other embodiments, the insect sensor may be mounted on the vehicle in a different manner, e.g. not including an arm or frame.

The illumination module 131 comprises a light source, such as one or more halogen lamps, one or more LEDs or the like, configured to illuminate an illuminated volume in front of the vehicle. The illumination module may be communicatively coupled to the dispensing control unit 140 so as to allow the dispensing control unit to control operation of the illumination module. The detector module 130 comprises one or more detectors and one or more optical elements configured to capture backscattered light from at least a portion of the illuminated volume and to guide the captured light onto the one or more detectors. The illuminated volume from which light is captured by the detector module for detecting insects is referred to as detection volume 150. The detector module 130 is communicatively coupled to the dispensing control unit 140 and forwards detector signals, optionally processed detector signals, to the dispensing control unit. The dispensing control unit processes the received detector signals so as to detect insects in the detection volume. Based on the detected insects, the dispensing control unit 140 controls operation of the dispensing device so as to cause the dispensing device to dispense insecticide corresponding to the detected insects in the detection volume. In some embodiments, the dispensing control unit may control the dispensing device to dispense the insecticide when the dispensing device reaches the location of the detection volume on which the dispensing decision was made. Alternatively, the insect sensor comprises a processor configured to perform the insect detection and to forward information about the detected insect population to the dispensing control system.

Hence, as the vehicle travels along a travelling path, the detector module captures light from a detection volume in front of the vehicle, i.e. the detection volume also travels along the travelling path, ahead of the vehicle. The dispensing control unit may thus continuously (or at least intermittently) control the dispensing device to adjust the dispensing of the insecticide to the currently (or most recently) detected insects in front of the vehicle. It will be appreciated that the adjustment may be delayed so as to account for the relative delay of the movement of the dispensing device relative to the detection volume along the travelling path, and taking the latency of the analysis of the detector signals into account. In other embodiments, the control of the dispensing device may occur after the vehicle has already passed the detection volume on which the control is based. However, the inventors have realised that such a delay is acceptable and still results in a sufficiently fine-grained adaptation of the dispensing of insecticides.

FIG. 2 schematically illustrates operation of an apparatus for spraying insecticides. In particular, FIG. 2 illustrates considerations for selecting the size and shape of the detection volume.

FIG. 2 shows an insect sensor 120 and the dispensing device 110 of the vehicle of FIG. 1. The insect sensor and the dispensing device travel along the direction of travel 101 such that the insect sensor travels ahead of the dispensing device. The insect sensor is forward-facing and monitors a detection volume 150 that also travels along the direction of travel 101, ahead of the insect detector.

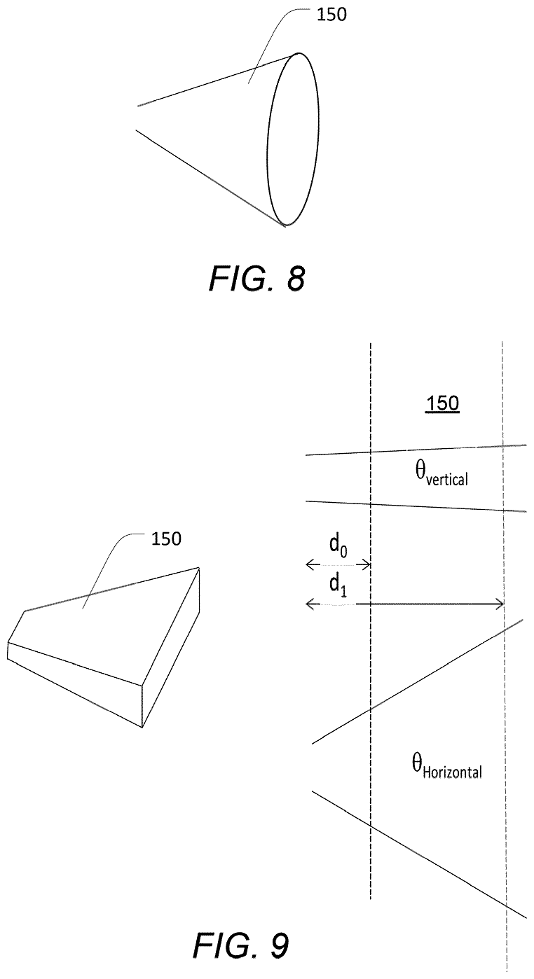

In FIG. 2, the detection volume is illustrated as a box-shaped volume having a height H, a width W and depth D. It will be appreciated, however, that the detection volume may have a different shape, other than box-shaped. Preferred embodiments of a detection volume will be described below with reference to FIGS. 8 and 9. Generally, the shape and size of the detection volume and the position of the detection volume relative to the vehicle are determined by the illumination module and by the detector module of the insect sensor. Generally, the detection volume may be defined as the volume from which the detection module obtains sensor signals useful for detecting insects. The detection volume is typically defined by an overlap of the volume illuminated by the illumination module and by the field of view and depth of field of the detector module.

The insect detection may be performed based on signals recorded over a sampling period t. Generally, when the insect sensor is movable relative to a ground surface, e.g. because the insect sensor is mounted on a moving vehicle, the detection volume moves relative to the ground surface. Accordingly, when the sensor data is indicative of detected insects in the detection volume during a period of time t, the sensor data is indicative of detected insects within a space traversed by the moving detection volume during time t. Here and in the following, the volume traversed by the moving detection volume during a sampling period t will also be referred to as sampling volume. Accordingly, sensor data indicative of detected insects in the detection volume may provide an estimate of a local insect population within the sampling volume above the ground surface, the sampling volume being traversed by the detection volume during relative movement of the detection volume relative to the ground surface during the sampling period t. For example, when the vehicle travels at constant speed v across a ground surface, the total sampling volume sampled during the sampling period t is thus Vₛₐₘₚₗₑ=V₀+A*v*t, where V₀ is the detection volume (in the above example V₀=H*W*D) and A is the cross sectional area of the sampling volume in the direction of travel (in the above example A=W*H).

The inventors have realised that, in order to make a decision as to whether to spray insecticide or not, it is preferred to locally sample at least a sampling volume of 1 m³ in order to get a result representative of the insect population.

Assuming a travelling speed of the vehicle of 20 km/h and a distance between the insect sensor and the detection volume of 6 m, a box-shaped detection volume having a height of H=1 m, a width of W=1 m and a depth of D=0.6 m, the detection volume is V₀=0.6 m³ and sampling of a sampling volume of V=1 m³ requires t=0.1 s. However, larger detection volumes may be preferable so as to provide more accurate detection results. Accordingly, for typical vehicle speeds of farming vehicles, detection volumes of at least 0.2 m³, such as at least 0.5 m³, such as at least 1 m³, such as at least 2 m³ have been found suitable.

Another consideration relates to the shape of the detection volume. In order to allow for a reliable detection and identification of an insect (e.g. to be able to determine an insect's wing beat frequency), the insect should preferably remain in the detection volume for at least 0.1 s. In order to allow insects to remain in the detection volume as long as possible, regardless of the direction of travel of the insect (and regardless of the movement of the detection volume along the direction of travel), the linear dimensions of the detection volume should be similar along all directions. However, in practice, aspect ratios between the longest extent of the detection volume and the shortest extent of the detection volume of no more than 10:1, preferably no more than 5:1, preferably no more than 3:1, more preferably no more than 2:1 have been found suitable.

Yet another consideration relates to the position of the detection volume 150 relative to the vehicle and relative to the ground. In some embodiments, the detection volume may be selected sufficiently far ahead of the vehicle so as to allow the dispensing control unit (or other processor) to perform the necessary data processing so as to obtain a detection result within the time it takes for the dispensing device to travel the distance between the dispensing device and the detection volume. On the other hand, the detection volume should be sufficiently close to the vehicle so as to ensure that the detected insect population accurately reflects the insect population at a location when the dispensing device reaches said location. If the detection volume is too far removed from the dispensing device, the insect population may have changed considerably by the time the dispensing device has travelled the distance between the dispensing device and the detection volume.

The preferred vertical offset of the detection volume from the ground and/or the height of the detection volume may depend on the type of crops/vegetation and on the type of insects to be detected. For airborne insects and optical insect sensors, the detection volume is preferably located above, most preferably immediately above a reference plane. The reference plane may e.g. be defined the vegetation canopy of the area or land or by another horizontal plane positioned at a vertical offset above the ground surface.

In the following, embodiments of an insect sensor will be described which may be mounted on an agricultural vehicle, e.g. as described in connection with FIG. 1, or which may otherwise be deployed, e.g. stationary or mobile.

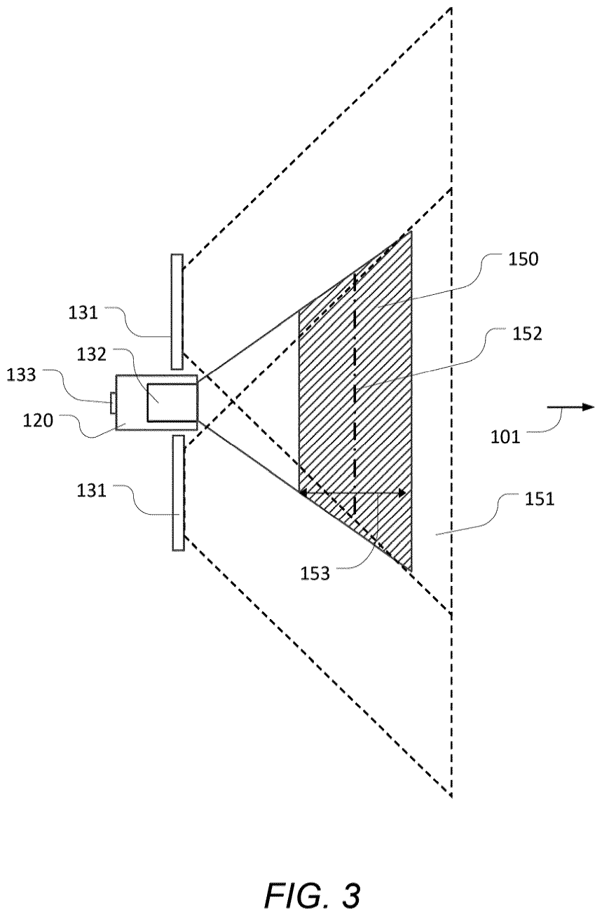

FIG. 3 schematically illustrates an embodiment of an insect sensor. The insect sensor comprises a forward facing detection module 130 and an illumination module 131. In this example, the illumination module is formed as two elongated arrays of LEDs. Each array extends laterally from either side of the detector module. The arrays define an illumination volume 151 illuminated by both arrays. The detector module comprises an imaging system operable to image an object plane 152 inside the illuminated volume onto at least one image plane of the detector module. The field of view of the imaging system and the depth of field 153 of the imaging system are configured such that the imaging system images at least a portion of the illuminated volume onto an image plane of the detector module. The portion of the illuminated volume imaged by the imaging system such that it can be detected by one or more detectors of the detector module and used for insect detection defines the detection volume 150.

For example, the detector module may include an image sensor, e.g. a CCD or CMOS sensor, so as to allow imaging of insects within the Illuminated volume. It has been found that imaging of insects in a detection volume is suitable for identifying insects based on trajectories of insects moving within the detection volume, i.e. within the depth of field of the imaging system. This allows detection and identification even of insects that are difficult or impossible to detect and identify based on wing beat frequencies. An example of such an insect is the jumping Cabbage Stem Flee Beatle.

For example, an imaging system based on a camera lens having f=24 mm, f/2.8 and a 3/4″ image sensor configured to focus on an object plane at 2 m distance from the lens, the field of view is approximately 1.7 m×1.7 m and the depth of field is approximately 1.3 m, thus resulting in a detection volume of approx. 3.7 m³.

It will be appreciated that other imaging systems may be used. Also, additional and alternative detectors may be used.

It will further be appreciated that the illumination module may be arranged in a different manner relative to the detector module and/or include a different type and/or number of light sources.

Generally, in order to maximize the amount of backscattered light from insects inside the detection volume, it may be preferable to position the illumination module adjacent or otherwise close to the detector module, such that the illumination direction and the viewing direction only define a relatively small angle between them, e.g. less than 30°, such as less than 20°. In some embodiments, the illumination module is configured to emit a beam of light along an illumination direction, and the detector module defines a viewing direction, e.g. as an optical axis of the detector module, wherein the illumination direction and the viewing direction define an angle between each other, the angle being between 1° and 30°, such as between 5° and 20°.

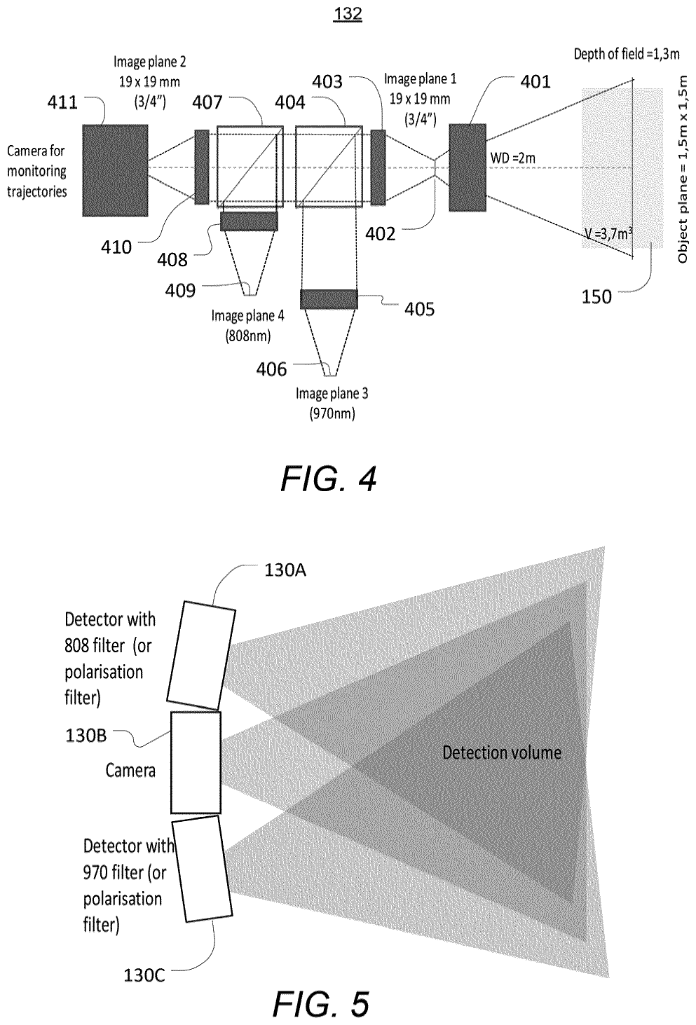

FIG. 4 schematically illustrates an example of a detector module of an insect sensor. The detector module comprises an image sensor 411 and two photodiode arrays 405 and 409, respectively. The image sensor 411 records an image of a detection volume 150 as described above. To this end the detector module comprises lenses 401, 403 and 410 for imaging on object plane in the detection volume at a suitable depth of field onto the image sensor. In particular, lens 401 images the object plane onto a virtual image plane 420. Lens 403 collimates the light from the virtual image plane and lens 410 focusses the collimated light onto the image sensor. A part of the collimated light is directed by beam splitter 404 towards another lens which focusses the light onto photodiode array 405.

Similarly, another portion of the collimated light is directed by beam splitter 407 onto lens 408 which focusses the light onto photodiode array 409. The beam splitter 404 is configured to selectively direct light at a first wavelength, e.g. 970 nm, onto photodiode array 405, while beam splitter 407 is configured to selectively direct light at a second, different, wavelength, e.g. 808 nm, onto photodiode array 409.

The photodiodes of each arrays thus detect time-resolved backscattered light from respective portions of the detection volume. Alternatively, the photodiode arrays may be replaced by individual photodiodes or by image sensors.

Based on the thus obtained signals, the system may detect insects in the respective parts of the detection module based on detected wing beat frequency, glossiness and/or melanisation, e.g. as described in WO 2018/182440.

Similarly, based on the recorded images by the image sensor 411, the system may determine additional or alternative indicators from which the presence and, optionally, identity of insects may be obtained. To this end, the process may utilise suitable computer vision techniques, such as object recognition and/or the detection and recognition of trajectories of insect movements, e.g. as described in co-pending International patent application No. PCT/EP2019/073119.

It has been found that a combination of different detector signals and, hence, different types of indicators allows for a particularly reliable detection of insects, including insects that are only difficult to detect based on e.g. wing beat frequency alone.

Nevertheless, it will be appreciated that other embodiments of detector modules may include only one or some of the above detectors, e.g. only an image sensor, or only an image sensor in combination with a single photodiode or photodiode array, or only a combination of two photodiodes or photodiode arrays. Also, in alternative embodiments, photodiodes or photodiode arrays may be configured to selectively detect light at alternative or additional wavelengths.

Yet further, while the embodiment of FIG. 4 utilises a combined optical system to direct light onto multiple sensors, alternative detector modules may comprise separate detectors, each having their own optical system, e.g. as illustrated in FIG. 5 below.

FIG. 5 schematically illustrates another example of a detector module of an insect sensor. In particular, FIG. 5 illustrates a detector module comprising three detectors 130A-C, respectively, each receiving light from a common detection volume that is illuminated by a common illumination module (not shown). In yet alternative embodiments, the detectors may receive light from different detection volumes which may be illuminated by a common or by respective illumination modules. Each of the detectors 130A-C include their own optical system, e.g. their own lenses etc.

In the present example, the detector module comprises a detector 130A for detecting light at a first wavelength and, optionally, at a first polarisation state. To this end, detector 130A may comprise a suitable band-pass filter, e.g. a filter selectively allowing light of 808 nm to reach a sensor of the detector, e.g. a photodiode or photodiode array. The detector 130A may further comprise a polarisation filter.

Detector 130B includes a digital camera, e.g. as described in connection with FIG. 3 or 4.

Detector 130C is configured for detecting light at a second wavelength (different and spaced apart from the first wavelength) and, optionally, at a second polarisation state. To this end, detector 130C may comprise a suitable band-pass filter, e.g. a filter selectively allowing light of 970 nm to reach a sensor of the detector, e.g. a photodiode or photodiode array. The detector 130C may further comprise a polarisation filter.

It will be appreciated, that alternative insect sensors may comprise additional or alternative detectors, e.g. fewer than three or more than three detectors.

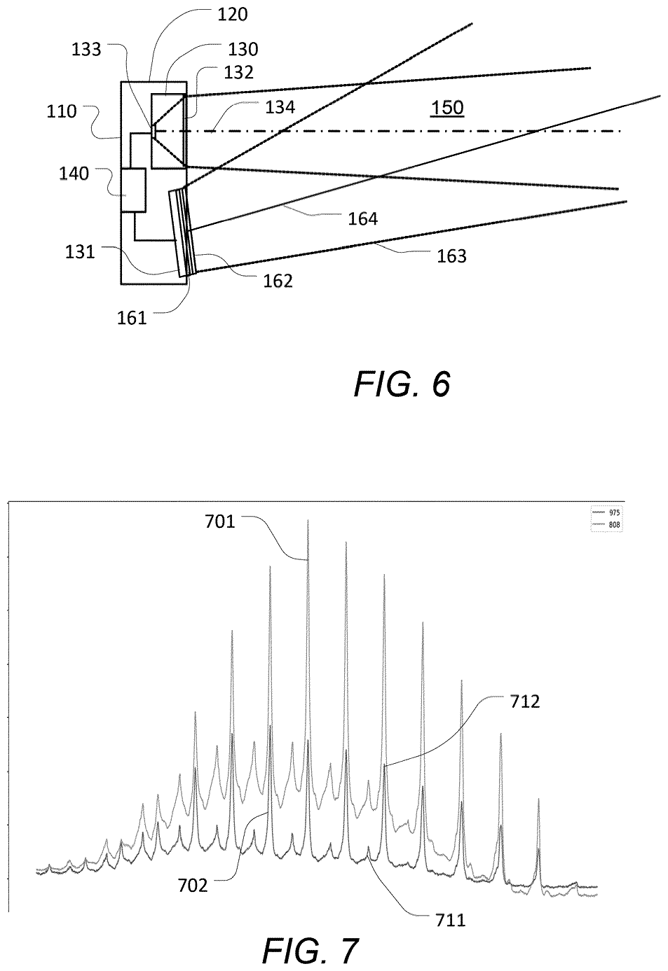

FIG. 6 schematically illustrates another embodiment of an insect sensor. The insect sensor, generally designated by reference numeral 120, comprises a processing unit 140, a detector module 130 and an illumination module 131, all accommodated within a housing 110. In this example, the illumination module and the detector module are vertically aligned with each other and the illumination module is arranged below the detector module. However, other arrangements are possible as well.

The illumination module comprises an array of light-emitting diodes (LEDs) 161 and a corresponding array of lenses 161 for directing the light from the respective LEDs as a diverging beam 163 along an illumination direction 164. The array of light emitting diodes may comprise a first set of diodes configured to selectively emit light at a first wavelength range, e.g. at 810 nm+/−25 nm. The array of light emitting diodes may further comprise a second set of diodes configured to selectively emit light at a second wavelength range, different from the first wavelength range, in particular spaced-apart from the first wavelength range, e.g. at 980 nm+/−25 nm. In other embodiments, the array of light emitting diodes may include alternative or additional types of LEDs. For example, in some embodiments, the LEDs may be configured to emit broad-band visible, near-infrared and/or infrared light.

The detector module 130 comprises an optical system 132 in the form of a Fresnel lens. Alternative another lens system may be used. The detector module 130 includes an optical sensor 133, e.g. one or more photodiodes, such as an array of photodiodes, a CCD or CMOS sensor and the optical system directs light from the detection volume onto the optical sensor. In some embodiments, the optical system images an object plane 152 inside the illuminated volume onto the optical sensor. The field of view of the optical system and the depth of field of the optical system are configured such that the optical system directs light from a portion of the volume illuminated by the illumination module onto the optical sensor. The portion of the illuminated volume from which the optical system receives light such that it can be detected by the optical sensor and used for detection of insects defines a detection volume 150. The optical system 132 defines an optical axis 134 that intersects with the illumination direction 164 at a small angle, such as 10°.

For example, when an optical system is based on a camera lens having f=24 mm, f/2.8 and an optical sensor includes a 3/4″ image sensor, the detector module may be configured to focus on an object plane at 2 m distance from the lens, corresponding to a field of view of approximately 1.7 m×1.7 m and a depth of field of approximately 1.3 m, thus resulting in a detection volume of approx. 3.7 m³.

The detector module 130 is communicatively coupled to the processing unit 140 and forwards the captured radiation by the optical sensor to the processing unit. The processing unit 140 may include a suitably programmed computer or another suitable processing device or system. The processing unit receives the sensor signal, e.g. an image or stream of images and/or one or more time series of sensor signals from respective one or more photodiodes and, optionally, further detector signals from the detector module and processes the received sensor signal so as to detect and identify insects in the detection volume and output sensor data indicative of an estimated insect population.

FIG. 7 schematically illustrates an example of a sensor signal form a detector module of an embodiment of an insect sensor as described herein, e.g. an insect sensor as described in connection with any of the previous figures. In this example, the sensor signal from the detector module includes respective time series of detected light intensities at two narrow wavelength bands, e.g. as recorded by respective photodiodes provided with respective bandpass filters. In some embodiments the signal may be integrated or otherwise combined from multiple photodiodes, from an image sensor and/or the like.

In this example, time series 701 corresponds to detected light at 808 nm while time series 702 corresponds to detected light at 975 nm. However, other embodiments may use other wavelengths and/or more than two wavelengths or wavelength bands.

The processing unit of an insect sensor may process the times series to detect the presence of an insect in the detection volume and, optionally determine the type of detected insect. Alternatively, some or all of the signal and data processing may be performed by a data processing system external to the image sensor.

In the present example, the process implemented by the processing unit and/or an external data processing system may detect the presence of detected radiation above a predetermined threshold and/or determine a fundamental harmonic of the detected frequency response so as to detect the presence of an insect.

Alternatively or additionally the process may compute one or more indicators from which a type of insect may be determined. Examples of such indicators include a fundamental wing beat frequency (WBF), a body-wing ratio (BWR) and a melanisation (MEL).

For example, the process may compute the fundamental wing beat frequency (WBF) from the determined fundamental harmonic of the frequency response of a detected detection event. The process may compute the body-wing ratio as a mean ratio between a wing and body signal. The body signal may be determined as a baseline signal 711 of a detection event which represents the scattering from the insect with closed wings while the wing signal may be determined as the signal levels 712 at the peaks in scattering,

The melanisation ratio may be determined as a mean ratio between the signal strengths of the two recorded channels during a detection event.

From one or more of the above indicators, optionally in combination with other parameters, the process may determine a type of insect, e.g. a species of insects. This determination may be based on suitable look-up tables, on a classification model, such as a machine learning model, or the like.

Other examples of parameters detectable by embodiments of the insect sensor described herein and suitable for the detection and/or classification of flying or jumping insects include detected movement trajectories of insects within the detection volume, e.g. as described in co-pending International application No. PCT/EP2019/073119 the entire contents of which are hereby incorporated herein by reference.

Generally, embodiments of the insect sensor described herein provide a detection volume that is large enough for the detector module to observe a number of insects representative for the population density in the area, e.g. an area to be treated with pesticides. The detection volume is also small enough to be sufficiently uniformly illuminated so as to provide high signal strength at the image sensor.

Moreover, embodiments of the apparatus described herein provide fast observation times, e.g. so as to provide actionable input to a control system of a pesticide sprayer moving about an area to be treated.

Moreover embodiments of the apparatus described herein provide long enough observation times to be able to reliably classify flying insects.

FIGS. 8 and 9 illustrate examples of detection volumes. FIG. 8 schematically shows an example of a frusto-conical detection volume resulting from an illumination module emitting a diverging light beam with a generally circular cross section. FIG. 9 schematically illustrates an example of a frusto-pyramidal detection volume.

In order to make a spraying decision it is preferable that the recorded insect activity is representative for the area under consideration. In order to achieve this, a sufficiently high counting statistics is needed. The inventors have found that observation of at least 10, preferably at least 50, more preferably at least 100 insects allows for sufficiently representative insect activity.

The inventors have further found that typical numbers of insect activities observed in relevant areas of land are in the range from 0.2-2 insects pr. second pr. m³. When mounted on a moving vehicle, the detection volume V is moving forward with the speed, v of the moving vehicle. Assuming e.g. that the detection volume of the sensor is of the order 3 m³ and assuming an insect activity of 1 insect pr. second pr. m³, 33 seconds are needed in order to achieve a count of 100 insects. For a vehicle moving with 20 km/h this would mean that the vehicle has moved forward approx. 110 m. Considering typical lengths of spraying booms and considering that typical sizes of areas to be treated may exceed several tens of hectares, this provides for a sufficient detection resolution to support localized spraying decisions to be made for respective parts of an area of land to be treated.

As described herein, some embodiments of the insect sensor described herein record one or more time series of light scattering off one or more insects in flight at one or more wavelengths of the light. From the recorded time series, the wing beat frequency and/or ratio of scattering from body and wings, respectively, can be computed. However, in order to obtain a reliable and accurate detection result, the recorded time series should be long enough for multiple wingbeats to occur. The wingbeat frequency of insects in flight spans from around 100 Hz to around a 1000 Hz. In order to get more than 10 wings beats the time the insect is in the detection volume should, in the worst case, be preferably more than 100 ms. Similarly, a detection based on recorded flight trajectories is facilitated by observation times long enough to record trajectories of sufficient lengths.

Embodiments of the insect sensor described herein thus employ a detection volume shaped and sized to allow sufficiently long observation times, even when sensor is moving across an area of land.

A typical agricultural vehicle may move at a speed of e.g. 20 km/h or at similar speeds across an area of land. When moving at such a speed, during 100 ms the vehicle and, hence, the detection volume will have moved forward 0.55 m. Therefore, the extent of the detection volume along the direction of travel of the vehicle should preferably be larger than 1 m, such as larger than 2 m, such as larger than 5 m in order to ensure that insects are likely to remain inside the moving detection volume sufficiently long. For example, the length of the detection volume along the direction of travel may be less than 100 m, such as less than 50 m, such as less than 20 m.

Furthermore, as discussed above, it is preferred that the detection volume is of the order of, or larger than, 1 m³ such as larger than 1 m³. In order to achieve such a detection volume with a small and cost-efficient image sensor, it is preferred that the illumination module is carefully configured.

The illuminated detection volumes shown in FIGS. 8 and 9 both provide large detection volumes in the vicinity of the image sensor, i.e. allowing representative and local measurements.

The detection volumes shown in FIGS. 8 and 9 represent an overlap between an illuminated volume, illuminated by an illumination module of the insect sensor, and by a detectable volume from which a detector of the insect sensor receives light, i.e. the detectable volume may be defined by a field of view and depth of field of the detector. In one embodiment, the illumination module comprises one or more suitable light sources, e.g. one or more high-power LEDs, emitting light which is diverging from the illumination module so as to distribute light into a large volume. In one particular embodiment, the illumination module is configured to emit light with a full divergence angle in the horizontal plane that is larger than 5°, such as larger than 10° such as larger than 20°, while the vertical divergence is limited to angles smaller than 2° such as smaller than 5°. This embodiment is preferred as the resulting detection volume consequently will be optimized in space just above the crop. Moreover, in this embodiment, the amount of light which disappears upwards or into the crop is limited.

It is further preferred that the illumination module is configured so as to direct the illumination light along a center optical axis of the radiated light (i.e. along a direction of illumination) that points upwards in such an angle as to completely eliminate light form hitting the crop, e.g. between 1° and 30°, such as between 2° and 30°, such as between 5° and 20°.

An example of a detection volume resulting from such a diverging, pie-shaped, forward-upwardly directed illumination beam is illustrated in FIG. 9. In particular, FIG. 9 illustrates a 3D view of the detection volume 150 as well as a side view and a top view of the detection volume. In the example of FIG. 9, the distance do between the aperture of the detector module and the start of the detection volume is about 1 m. The distance d₁ between the aperture of the detector module and the far end of the detection volume is about 10 m. The divergence angle θ_{vertical} of the diverging light beam in the vertical direction (full angle) is about 4° while the divergence angle θ_{Horizontal} in the horizontal direction (full angle) is about 20°. However, it will be appreciated that other embodiments may have different size and/or shape.

Generally, when the detection volume is positioned close to the insect sensor efficient illumination of the detection volume and reliable detection of small insects is facilitated. Moreover dispensing control based on the detection of local insect populations is facilitated. For example, the boundary of the detection volume closest to an aperture of the detector module may be between 10 cm and 10 m away from the aperture of the detector module, such as between 10 cm and 5 m, such as between 10 cm and 2 m. The boundary of the detection volume furthest from an aperture of the detector module may be between 3 m and 100 m away from the aperture of the detector module, such as between 5 m and 20 m, such as between 8 m and 12 m.

Although the invention has been described with reference to certain specific embodiments, various modifications thereof will be apparent to those skilled in art without departing from the spirit and scope of the invention as outlined in claims appended hereto.

1. An apparatus for dispensing an insecticide across an area of land, the area of land defining a ground surface, the apparatus comprising:
a vehicle configured to travel along a travelling path across the ground surface, the vehicle defining a direction of travel, the vehicle comprising an insecticide dispensing device configured to dispense an insecticide along said traveling path when the vehicle travels along the travelling path;
a dispensing control system configured to control an amount of insecticide to be dispensed when the vehicle travels along the travelling path;
an insect sensor configured to detect airborne insects in a detection volume while the detection volume moves relative to the ground surface; wherein the detection volume is located in front of the vehicle relative to the direction of travel and elevated above the ground surface by a minimum vertical offset;
wherein the dispensing control system is configured to receive sensor data from the insect sensor, the sensor data being indicative of detected insects in the detection volume, and to control the amount of dispensed insecticide responsive to the received sensor data.

2. An apparatus according to claim 1; wherein the detection volume has a size of at least 0.2 m³, or at least 0.5 m³, or at least 1 m³, or at least 2 m³, or at least 3 m³.

3. (canceled)

4. An apparatus according to claim 1; wherein the detection volume has an aspect ratio, defined as a ratio of a largest edge to a smallest edge of a minimum bounding box of the detection volume, of no more than 10:1, or no more than 5:1, or no more than 3:1, or no more than 2:1.

5-10. (canceled)

11. An apparatus according to claim 1; wherein the insect sensor comprises an illumination module configured to illuminate the detection volume and one or more detectors configured to detect light from the detection volume or wherein the illumination module is configured to simultaneously illuminate the entire detection volume.

12. An apparatus according to claim 11; wherein the illumination module includes a light source configured to emit incoherent light, wherein the light source includes one or more light emitting diodes and/or one or more halogen lamps.

13. An apparatus according to claim 11; wherein the illumination module is configured to emit a diverging beam of light having a divergence angle in at least one direction of between 2° and 45°, or between 10° and 30°.

14-16. (canceled)

17. An apparatus according to claim 11, wherein the illumination module comprises a first light source configured to selectively emit light at a first wavelength range, and wherein the illumination module further comprises a second light source configured to selectively emit light at a second wavelength range, spaced-apart from the first wavelength range.

18. An apparatus according to claim 11; wherein the one or more detectors comprise a camera and/or one or more photo diodes and are configured to selectively detect light within a first wavelength band and within a second wavelength band, non-overlapping with the first wavelength band.

19. (canceled)

20. An apparatus according to claim 18; wherein the one or more detectors comprise at least one photodiode array, each photodiode of the array being configured to receive light from a respective sub-volume of the detection volume.

21. (canceled)

22. An apparatus according to claim 11; wherein the insect sensor comprises a processor configured to identify, from detector signals from the one or more detectors, one or more types of insects and to determine respective amounts of the one or more types of insects detected in the detection volume, in particular based on one or more indicators chosen from:
a detected trajectory of movement of an insect inside the detection volume;
a detected speed of movement of an insect inside the detection volume;
one or more detected wing beat frequencies;
a melanisation ratio;
an insect glossiness.

23. An insect sensor for detecting airborne insects moving above a ground surface, the insect sensor comprising:
an illumination module configured to illuminate a detection volume, the detection volume being elevated from the ground surface by a minimum vertical offset, and
one or more detectors configured to detected light from the detection volume;
wherein the illumination module is configured to emit a diverging beam of light having a divergence angle in at least one direction of between 2° and 45°, or between 10° and 30°.

24. An insect sensor according to claim 23; wherein the illumination module includes a light source configured to emit incoherent light, the light source including one or more light emitting diodes and/or one or more halogen lamps.

25-26. (canceled)

27. An insect sensor according to claim 23, wherein the illumination module is configured to simultaneously illuminate the entire detection volume.

28. An insect sensor according to claim 23, wherein the illumination module comprises a first light source configured to selectively emit light at a first wavelength range, and wherein the illumination module further comprises a second light source configured to selectively emit light at a second wavelength range, spaced-apart from the first wavelength range.

29. (canceled)

30. An insect sensor according to claim 23; wherein the one or more detectors are configured to selectively detect light within a first wavelength band and within a second wavelength band, non-overlapping with the first wavelength band.

31. An insect sensor according to claim 13; wherein the one or more detectors comprise at least one photodiode array, each photodiode of the array being configured to receive light from a respective sub-volume of the detection volume.

32-33. (canceled)

34. An insect sensor according to claim 23; wherein the vertical offset is chosen to be between 10 cm and 5 m, or between 20 cm and 3 m, or between 20 cm and 2 m, or between 50 cm and 2 m.

35. A method of controlling the spraying of insecticides, the method comprising the steps of:
detecting airborne insects moving about a detection volume, the detection volume being located in front of a moving vehicle and the detection volume being elevated above a ground surface by a minimum vertical offset;
controlling the dispensing of insecticides from said moving vehicle responsive to the detection of airborne insects.

36. (canceled)

37. A method according to claim 35; wherein the detecting comprises obtaining sensor data indicative of an estimated insect population within a sampling volume above the ground surface; the sampling volume being traversed by the detection volume during relative movement of the detection volume relative to the ground surface during the sampling period t.

38. (canceled)

39. A method according to claim 35, wherein the detection volume extends from a top of a vegetation canopy upwards.
